(19) United States
(12) Patent Application Publication
(10) Pub. No.: US 2011/0307726 A1
(43) Pub. Date: Dec. 15, 2011

(54) REMOTE CONTROL METHOD AND REMOTE CONTROLLER

(75) Inventors: Kazunori Kikuchi, Kanagawa (JP); Masahiro Nakano, Tokyo (JP); Takashi Tsurumoto, Saitama (JP); Takayoshi Yamasaki, Tokyo (JP); Shozo Horisawa, Chiba (JP); Kanahiro Shirota, Kanagawa (JP)

(73) Assignee: Sony Corporation, Tokyo (JP)

(21) Appl. No.: 13/202,238

(22) PCT Filed: Feb. 19, 2010
(86) PCT No.: PCT/JP2010/053025

§ 371 Date: Aug. 18, 2011

(30) Foreign Application Priority Data
Feb. 27, 2009 (JP) 2009-045195

(51) Int. Cl. G06F 1/32

(52) U.S. Cl. 713/323

(57) ABSTRACT

A remote controller 10 sets, in step S1, a period of time Tx in which a reception mode is maintained after an instruction is transmitted. A generated instruction is transmitted to a communication module 20 (in step S3). The communication module 20 converts the received instruction into a control signal and transmits the signal to an electronic apparatus 30 (in step S4). After a process is executed in response to an instruction, the electronic apparatus 30 outputs information to be returned to the remote controller 10 to the communication module 20 (in step S5). The communication module 20 transmits information (in step S6). The information is received within the period of time Tx after the instruction is transmitted. Thereafter, the reception mode is cancelled (in step S7). After the reception mode is cancelled, the remote controller 10 returns to a sleep mode and operates with the minimum power.

### TECHNICAL FIELD

The present invention relates to a remote control method and a remote controller which are applicable to wireless remote control of an electronic apparatus, for example.

### BACKGROUND ART

When a remote controller which controls an electronic apparatus such as a television receiver uses an ISM (Industrial, Scientific and Medical use) band in a 2.4 GHz band, influence caused by a shielding object is reduced when compared with an infrared method and a reachable distance is increased as advantages. Remote controllers operate using batteries, and therefore, should operate with low power consumption.

As one method for attaining the low power consumption, normally, a remote controller which is in a quiescent (sleep) state may be brought to an active state only when an instruction (or a command) is issued and brought to the sleep state again immediately after the instruction is issued. If such a remote controller is only used to control an electronic, apparatus any problem does not arise, but if the remote controller is required to receive information from the electronic apparatus, this method may not be used.

Japanese Unexamined Patent Application Publication No. 2008-306472 discloses low power consumption in a system in which a plurality of sensors are connected to a management server through a network. In Japanese Unexamined Patent Application Publication No. 2008-306472, required hardware is driven only when a task of data transmission from one of the sensors is executed, for example, and a low power consumption mode (hibernation) is entered when the task is terminated.

### DISCLOSURE OF INVENTION

### Technical Problem

The method disclosed in Japanese Unexamined Patent Application Publication No. 2008-306472 is used only when a transmission is performed, and a time setting regarding a reception operation after the transmission is not disclosed. Furthermore, when a period of reception-available time is to be set, it is not advantageous if a fixed time is set in accordance with a type of an instruction and content of a process in terms of power consumption. That is, a period of time required for returning information is varied depending on types of instructions.

Therefore, an object of the present invention is to provide a remote control method and a remote controller which attain lower power consumption when compared with existing remote controllers.

### Technical Solution

To address the above problems, according to the present invention, there is provided a remote control method of a remote controller which has a first communication unit capable of performing bidirectional communication and which communicates with a second communication unit capable of performing bidirectional communication so as to remotely control an electronic apparatus connected to the second communication unit, the remote control method including

a step of setting a period of reception-available time of the first communication unit in accordance with a type of an instruction to be transmitted,

a step of transmitting an instruction to the second communication unit, and

a step of changing the first communication unit and a control unit to be low power consumption states when the period of reception-available time has been elapsed after an instruction is generated.

According to the present invention, there is provided a remote controller which operates using a battery power source including

a first communication unit capable of performing bidirectional communication, and

a control unit controlling the first communication unit,

wherein the control unit sets a period of reception-available time of the first communication unit in accordance with a type of an instruction to be transmitted, changes the first communication unit and the control unit to be low power consumption states when the period of reception-available time has been elapsed after an instruction to a second communication unit connected to an electronic apparatus is generated.

### ADVANTAGEOUS EFFECTS

According to the present invention, states of a communication unit and a control unit are changed to low power consumption states after a set period of reception-available time starting after an instruction is transmitted. The period of reception-available time is set in accordance with a type of an instruction to be transmitted. Accordingly, an optimum period of reception-available time is set and an effect of reducing power consumption is enhanced.

### BRIEF DESCRIPTION OF DRAWINGS

FIG. 1 is a block diagram schematically illustrating a configuration of a system according to a first embodiment of the present invention.

FIG. 2 is a sequence diagram illustrating a flow of a process of the first embodiment of the present invention.

FIG. 3 is a sequence diagram illustrating another flow of the process of the first embodiment of the present invention.

FIG. 4 is a sequence diagram illustrating still another flow of the process of the first embodiment of the present invention.

FIG. 5 is a sequence diagram illustrating a still further flow of the process of the first embodiment of the present invention.

FIG. 6 is a block diagram schematically illustrating a configuration of a system according to a second embodiment of the present invention.

FIG. 7 is a diagram schematically illustrating a configuration of a remote controller according to the second embodiment of the present invention.

FIG. 8 includes block diagrams illustrating communication units according to the second embodiment of the present invention.

FIG. 9 is a sequence diagram illustrating a flow of a process of the second embodiment of the present invention.

FIG. 10 is a diagram schematically illustrating power consumption control according to the second embodiment of the present invention.

### BEST MODES FOR CARRYING OUT THE INVENTION

Hereinafter, embodiments of the present invention will be described. Note that the description is made in the following order.

### 1. First Embodiment

### 2. Second Embodiment

Note that the embodiments described below are preferred embodiments of the present invention and various preferred limitations are defined in terms of techniques. However, the scope of the present invention is not limited to these embodiments unless otherwise there is particularly described that the present invention is limited by the embodiments.

### 1. First Embodiment

### Outline of System

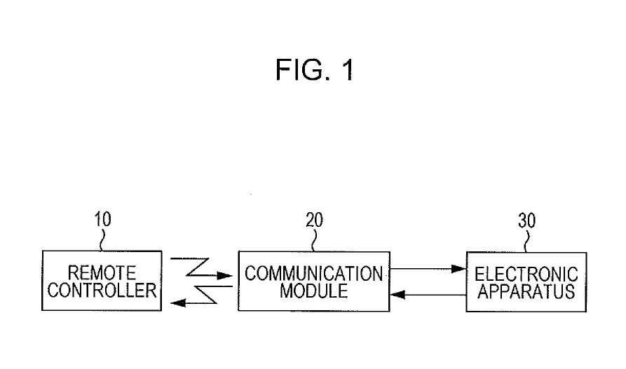

First embodiment includes, as shown in FIG. 1, a remote controller 10, a communication module 20, and an electronic apparatus 30 connected to the communication module 20. The remote controller 10 operates using a battery and includes an operation unit, a control unit, and a communication unit. For example, a communication module (first communication unit) included in the remote controller 10 and the communication module 20 (second communication unit) perform bidirectional wireless communication with each other. The electronic apparatus 30 is a television receiver, for example. The communication module 20 and the electronic apparatus 30 are connected to each other through a wired or wireless communication. The bidirectional communication between the communication modules is performed through a wireless transmission path in a 2.4 GHz band.

### “Operation in First Embodiment”

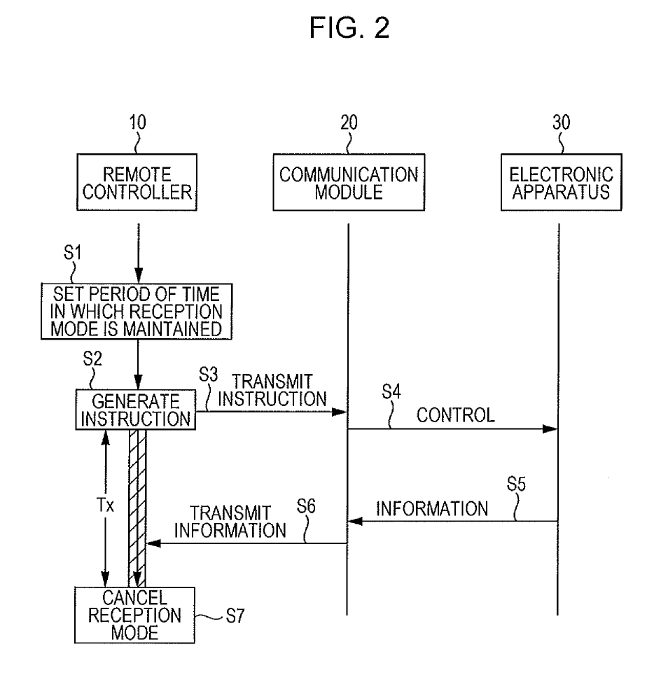

As shown in FIG. 2, in step S1, the remote controller 10 sets a period of time (a period of reception-available time) Tx in which a reception mode is maintained after an instruction is transmitted. A setting operation may be performed by a key operation by a user. However, the setting is automatically performed in accordance with an instruction to be transmitted from a control unit included in the remote controller 10. For example, a type of the instruction to be transmitted is set in accordance with content of a process to be executed. The set period of reception-available time is not changed until another setting operation is performed. Furthermore, the period of reception-available time is set for each software (a sub routine) executed by the control unit. In sequence diagrams shown in FIG. 2 onwards, a downward direction in the drawings represents a direction of elapsed time.

In next step S2, an instruction is generated. The generated instruction is transmitted to the communication module 20 (in step S3). The communication module 20 converts the received instruction into a control signal and transmits the control signal to the electronic apparatus 30 (in step S4). The remote controller 10 maintains a reception-available state (referred to as a “reception mode”) for a period of time Tx.

After executing a process in response to the instruction, the electronic apparatus 30 outputs, to the communication module 20, information to be returned to the remote controller 10 (in step S5). The communication module 20 transmits the information to the remote controller 10 (in step S6). The information is received within the period of time Tx after the instruction is transmitted. Thereafter, the reception mode is cancelled (in step S7).

After the reception mode is released, the remote controller 10 returns to a quiescent state and operates with minimum electric power. For example, a CPU of the control unit is brought to a sleep state and generation of a main clock is stopped. The process of setting the period of reception-available time (in step S1) is performed by the control unit, and therefore, electric power is consumed to some extent. However, the power consumption is smaller than that in the reception mode in which the communication modules are communication states.

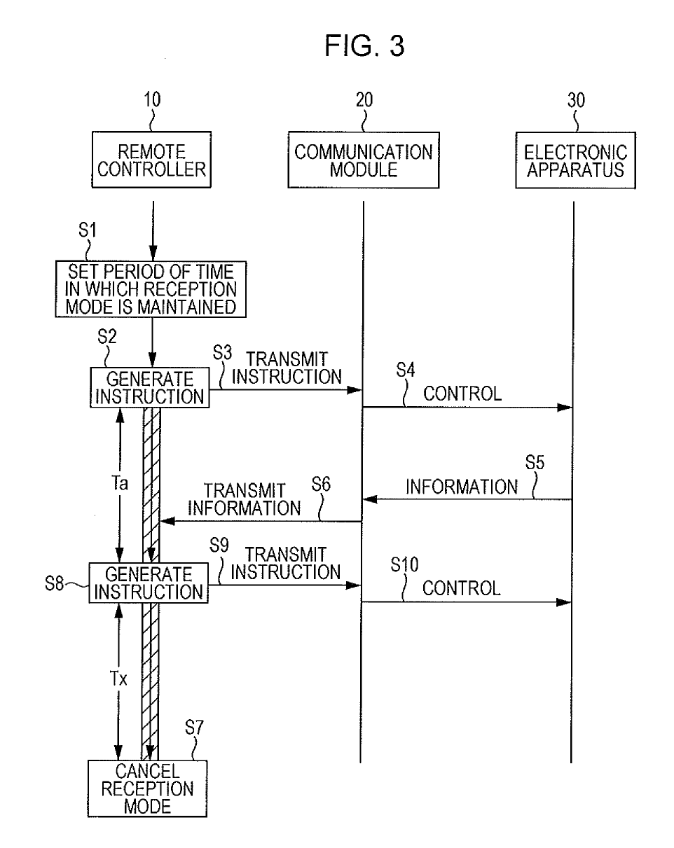

As shown in FIG. 3, after a period of time Ta (<Tx) elapsed after the process from step S1 to step S6 described above is performed, the remote controller 10 generates another instruction in step S8. The generated instruction is transmitted to the communication module 20 (in step S9). The communication module 20 converts the received instruction into a control signal and transmits the control signal to the electronic apparatus 30 (in step S10). The remote controller 10 maintains the reception mode for the period of time Tx. Thereafter, the reception mode is cancelled (in step S7).

In the example shown in FIG. 3, the communication module 20 does not transmit information in response to the second instruction. This situation occurs when a communication error occurred. Alternatively, this situation occurs when the remote controller 10 transmits an instruction so as to maintain the reception mode of the remote controller 10.

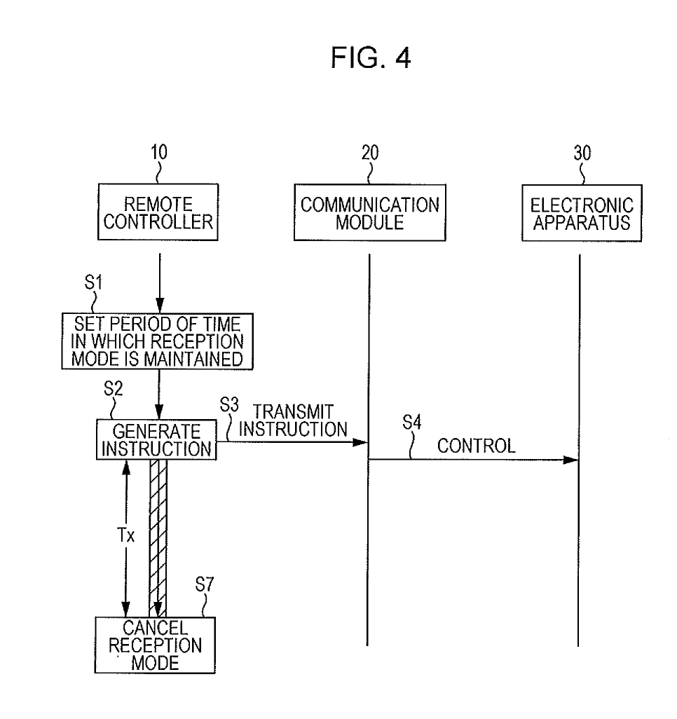

FIG. 4 shows a case where the period of time (the period of reception-available time) Tx in which the reception mode is maintained after an instruction is transmitted is set, an instruction is generated (in step S2), the instruction is transmitted (in step S3), and information is not received within the period of time Tx. Also in this case, similarly, the reception mode is cancelled in step S7.

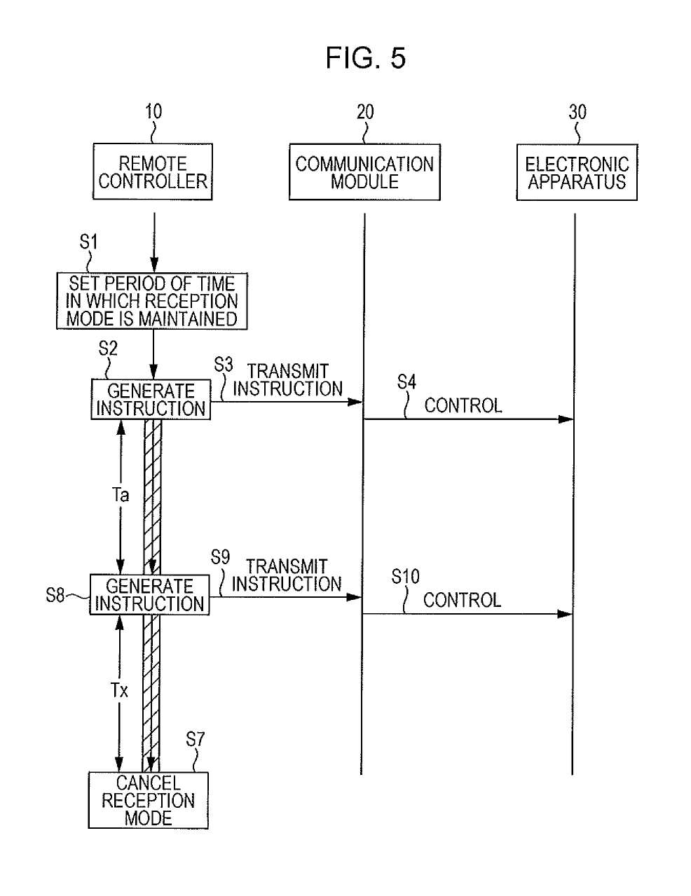

FIG. 5 shows a flow in which the period of time Tx in which the reception mode is maintained after an instruction is transmitted is set, an instruction is generated (in step S2), the instruction is transmitted (in step S3), another instruction is generated (in step S8), and the instruction is transmitted (in step S9). A case where information is not received within the reception-available times after the instructions are transmitted is shown as an example. Also in this case, similarly, the reception mode is cancelled in step S7.

As described above, in the first embodiment of the present invention, the reception mode is maintained within the set period of time Tx after an instruction is transmitted, and otherwise, at least the communication modules are brought to quiescent states. Accordingly, power consumption of the remote controller 10 may be reduced.

### 2. Second Embodiment

### Outline of System

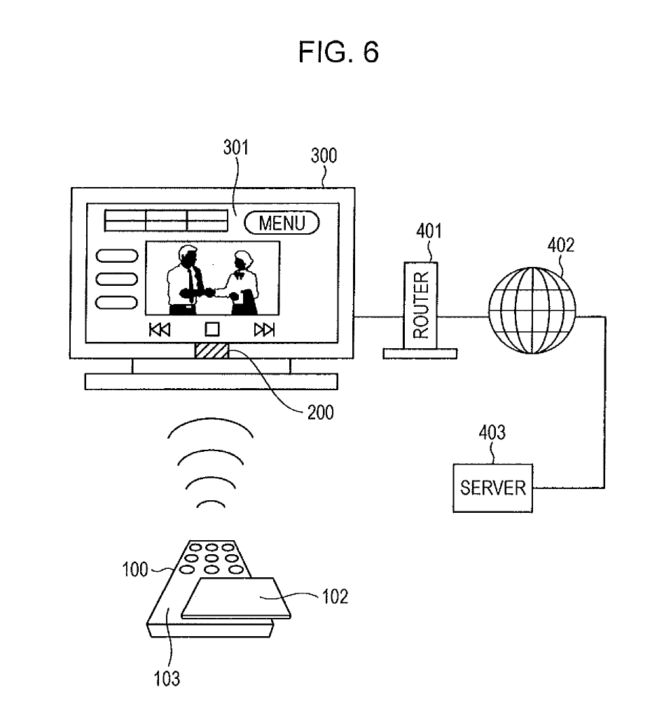

FIG. 6 schematically illustrates a configuration according to a second embodiment. In the second embodiment, a television receiver 300 serving as an electronic apparatus is connectable to a server 403 through a router 401 and the Internet 402. The server 403 is an AV (Audio Visual) server and distributes AV content specified by the user through the router 401 at home, a broadband network, and the Internet 402 to the television receiver 300. Furthermore, the server 403 has a function of a server which performs a charging process. The distributed AV content is stored in a storage device such as a hard disk included in the television receiver 300.

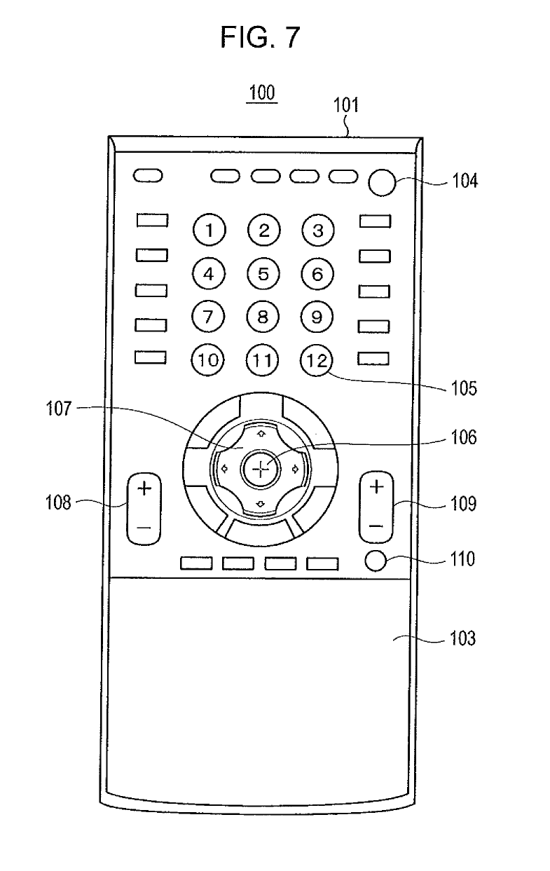

The television receiver 300 has a communication module 200 attached thereto so as to perform bidirectional wireless communication with the remote controller 100. The remote controller 100 includes, as shown in FIG. 7, a plurality of operation buttons disposed on a surface of a case, a transmission/reception unit 101 which transmits and receives an RF signal, and a reading face 103 used to read a prepaid card 102 (shown in FIG. 6) which is an electronic money. The prepaid card is a non-contact IC card using a proximal wireless technique.

Examples of the operation buttons include a power on/off button 104, number buttons 105, a determination button 106, a direction button 107, a volume up/down button 108, a channel up/down button 109, and a settlement button 110.

The remote controller 100 normally controls operation of the television receiver 300. Furthermore, as shown in FIG. 6, a content selection screen 301 may be displayed on a screen of the television receiver 300 so that desired content is specified by operating the remote controller 100. The content selection screen 301 includes tabs used to select a category and a preview screen.

For example, when the content selection screen 301 is displayed on the television receiver 300 and desired content is selected by operating the remote controller 100, a screen prompting the user to perform a settlement process is displayed in the screen of the television receiver 300. The user puts the prepaid card 102 near the reading face 103 of the remote controller 100 and presses the settlement button 110.

Information (user information, balance information, authentication information, and the like) on the prepaid card 102 is read by a reader disposed on a lower portion of the reading face 103. The read information is transmitted from the remote controller 100 to the communication module 200. Furthermore, the information on the prepaid card 102 is transmitted from the communication module 200 to the server 403 through the television receiver 300, the router 401, the broadband network, and the Internet 402.

After the server 403 performs a charging process, information representing that the charging process has been performed is transmitted to the television receiver 300 through the Internet 402, the broadband network, and the router 401. The information is further transmitted through the communication module 200 to the remote controller 100. The remote controller 100 notifies the user of normal termination of the charging process by blinking the settlement button 110 or by a beep. Then, the selected content is downloaded from the server 403 to the television receiver 300.

### “Example of Communication Module”

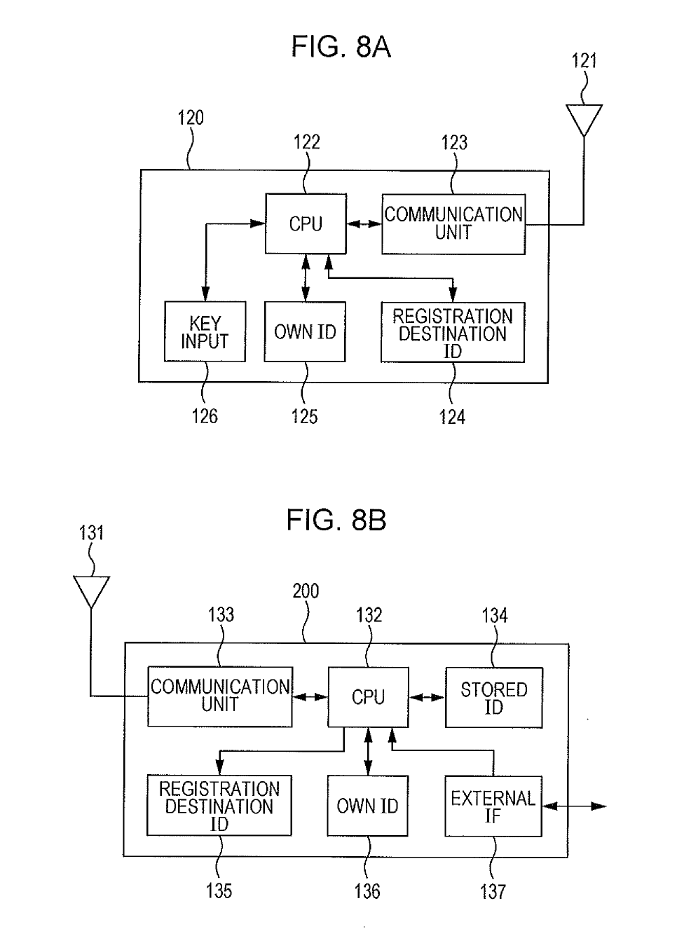

FIG. 8A shows a configuration of a communication module 120 disposed on the remote controller 100, and FIG. 8B shows a configuration of the communication module 200.

The communication module 120 of the remote controller 100 includes an antenna 121 which transmits/receives wireless electric waves. Furthermore, the communication module 120 includes a microprocessor (hereinafter referred to as a CPU (Central Processing Unit)) 122 serving as a control unit which operates programs corresponding to a communication process, read/write processes of storage media, and various key inputs. Moreover, the communication module 120 includes a communication unit 123 used for wireless communication, a storage medium 124 which stores identification information ID of a pairing partner, a storage medium 125 which stores an own ID, and a key input unit 126 having keys. The storage media 124 and 125 are constituted by writable nonvolatile memories, for example. The CPU 122 includes a ROM (Read Only Memory), and a RAM (Random Access Memory), and integrally controls the various units included in the communication module 120 by executing programs stored in the ROM and the like.

As the identification information, an EUI 64 (64-bit Extended Unique Identifier) which is an ID the same as a MAC address may be used. When a pairing operation and a normal communication operation are performed, the identification information is used as information on a transmission source and information on a transmission destination. The EUI 64 is identification information of 64 bits which is assigned to an interface of a communication apparatus.

As shown in FIG. 8B, the communication module 200 includes an antenna 131 which transmits/receives wireless electric waves, a CPU 132 which operates programs corresponding to a communication process, read/write processes of storage media, and various key inputs, a communication unit 133 used for wireless communication, a storage medium 136 which stores an own ID such as an EUI 64, and an external interface 137 to be connected to a control unit of a display unit 100. The CPU 132 integrally controls the units of the communication module 200.

Furthermore, the communication module 200 includes a storage medium 134 which includes an ID, e.g., a unique ID (EU164) of the communication module 120 which is a pairing destination (remote controller to be connected) written thereto in advance.

The communication unit 123 of the communication module 120 and the communication unit 133 of the communication module 200 perform bidirectional communication with each other in a predetermined wireless communication method. Note that the communication module 200 has a function of outputting a command received through wireless remote control to a control unit of the television receiver 300 connected through the external interface 137. Furthermore, information or a command is supplied from the television receiver 300 to the CPU 132 through the external interface 137, and the information may be transmitted from the communication module 200 to the communication module 120.

The communication unit 123 of the communication module 120 and the communication unit 133 of the communication module 200 may perform bidirectional wireless communication with each other in the same wireless communication method. As the wireless communication method, a physical layer of IEEE802.15.4 may be used. IEEE802.15.4 is a name of a standard of a short-range wireless network referred to as a PAN (Personal Area Network) or a W (Wireless) PAN. A communication rate of this standard is in a range from several tens of kilobits per second to several hundreds of kilobits per second, and a communication distance is in a range from several tens of meters to several hundreds of meters. Furthermore, communication is performed in a unit of frame. One frame has a size of 133 bytes at maximum including a payload (0 to 127 bytes) and a header (6 bytes).

### “Operation of Second Embodiment”

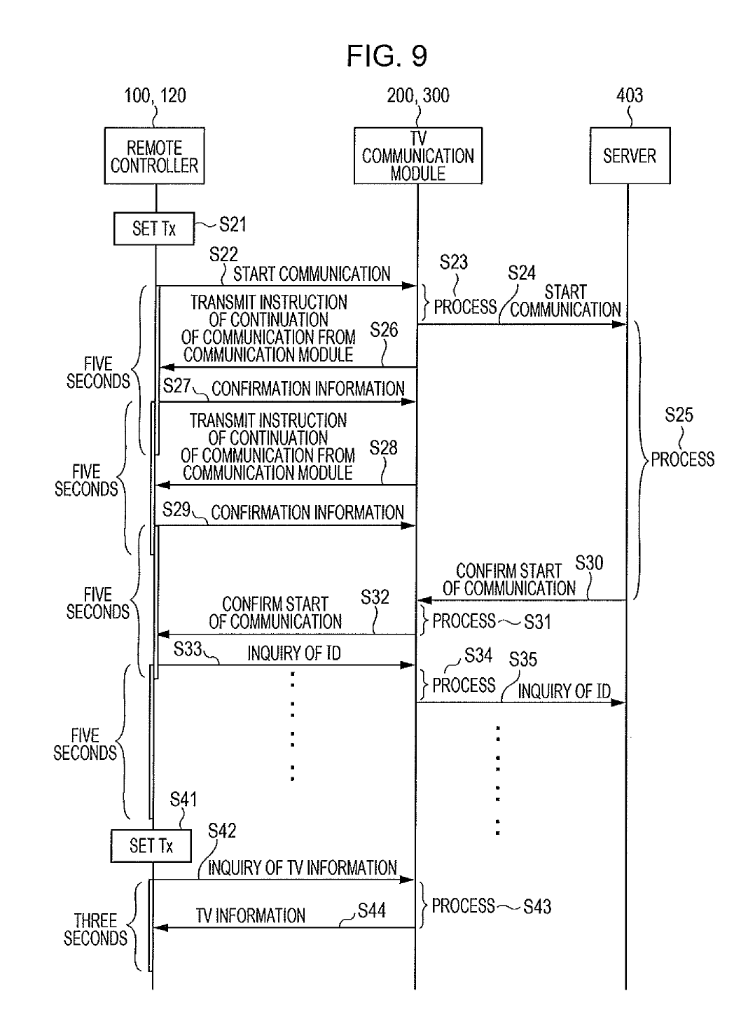

An example of an operation according to the second embodiment of the present invention will be described with reference to FIG. 9. Note that a process shown in FIG. 9 is performed under control of the CPU 122 included in the communication module 120 of the remote controller 100, the CPU 132 included in the communication module 200, a CPU included in the television receiver 300, and the like.

For example, the prepaid card 102 is put close to the reading face 103 of the remote controller 100 and the settlement button 110 is pressed. In step S21, a period of reception-available time Tx is set to 5 seconds, for example. The period of reception-available time Tx is set such that the period of reception-available time Tx is expected to be appropriate for an instruction to be transmitted. The instruction to be transmitted is determined in accordance with a process to be executed (subroutine). Here, a period of time which is appropriate for performing a series of processes to be performed when the settlement button 110 is set. The set period of reception-available time is maintained during the series of processes.

An instruction for starting communication including information read from the prepaid card 102 is transmitted to the communication module 200 (in step S22). The television receiver 300 performs a process such as a change of a screen (in step S23). Furthermore, the communication start including the information on the prepaid card 102 is transmitted to the server 403 (in step S24).

The server 403 processes the information on the prepaid card 102 and performs a charging process (in step S25). A certain period of time (longer than the period of reception-available time Tx) is required for the charging process. During this period of time, the connection between the remote controller 100 and the communication module 200 (television receiver 300) is preferably maintained. Therefore, an instruction for continuing the communication is transmitted from the communication module 200 within the Tx (five seconds) after the instruction for starting the communication is transmitted (in step S26). The communication module 120 of the remote controller 100 which received the instruction for continuing the communication transmits confirmation information to the communication module 200 (in step S27). After the confirmation information is transmitted, the period of reception-available time Tx is updated.

Furthermore, the communication module 200 transmits the instruction of continuing the communication again within the updated period of reception-available time Tx (in step S28). When receiving the instruction for continuing the communication, the communication module 120 of the remote controller 100 transmits confirmation information to the communication module 200 (in step S29). After the confirmation information is transmitted, the period of reception-available time Tx is updated again.

After the charging process of the server 403 is terminated, the server 403 transmits communication start confirmation to the television receiver 300 (in step S30). When receiving the communication start confirmation, the television receiver 300 performs a required process (in step S31). Then, the communication module 200 transmits the communication start confirmation to the communication module 120 of the remote controller 100 (in step S32).

When receiving the communication start confirmation within the period of reception-available time, the communication module 120 of the remote controller 100 transmits an ID inquiry to the communication module 200 (in step S33). Here, an ID is identification information unique to the communication module 200. The ID is a number (such as a serial number) assigned to each communication module, for example. The ID is used to confirm that the communication module 200 is a legitimate module, for example. When receiving the ID inquiry, the television receiver 300 performs a process such as a change of the display screen (in step S34). Then, the television receiver 300 transmits the ID inquiry to the server 403 (in step S35). Hereinafter, although not shown, processes are sequentially performed and a settlement process is finally completed.

As another example, an operation of submitting an inquiry of television information from the remote controller 100 to the communication module 200 (television receiver 300) will be described. For example, a display unit is disposed on the remote controller 100 which displays television information obtained from the television receiver 300. Examples of the television information include programs of channels different from a channel which is currently viewed, an EPG (Electorical Program Guide) screen, and reservation recording information.

In step S41, the period of reception-available time Tx is set. The period of reception-available time Tx is set to 3 seconds, for example, which is appropriate for a process of obtaining the television information. The communication module 120 of the remote controller 100 transmits an instruction for inquiry of the television information to the communication module 200 (in step S42).

When receiving the instruction for inquiry of the television information, the television receiver 300 performs a process such as a process of searching for the television information (in step S43). The communication module 200 transmits the television information to the communication module 120 of the remote controller 100 (in step S44). The process is performed in response to the inquiry of the television information without accessing the server 403. Accordingly, the shorter period of reception-available time Tx is set.

### “Power Consumption”

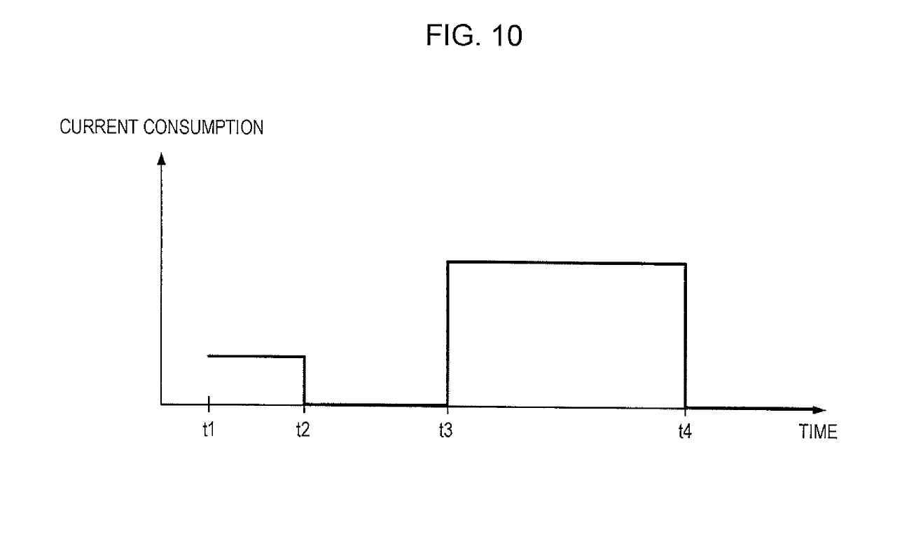

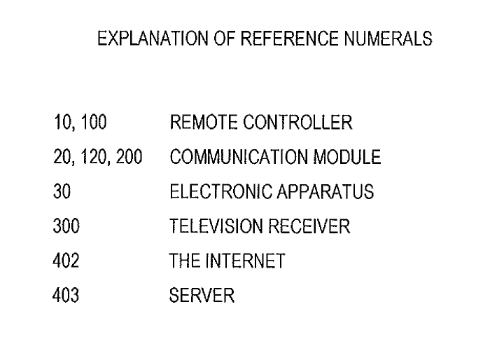

Power consumption is controlled in the second embodiment of the present invention as shown in FIG. 10. The power consumption in the first embodiment described above is similarly controlled. In a period of time from a timing t1 to a timing t2, various settings including a process of setting the period of reception-available time are performed. In this period of time, a current supplied from a battery power source is approximately several tens of mA (milliamperes).

In a period of time from the timing t2 to a timing t3, a sleep mode is entered. In the sleep mode, an internal clock of the communication module is stopped and a load current is equal to or smaller than 5 μA (microampere). The sleep mode is entered when the CPU controls levels of some of ports. In a period of time from the timing t3 to a timing t4, a communication mode (reception mode) is entered. In this period, a current of several tens of milliamperes flows. After the timing t4, the sleep mode is entered.

A period of time until next information is received is expected with reference to an instruction for transmission or a process, and the period of reception-available time is set in accordance with the expected period of time. Accordingly, a necessary and sufficient period of reception-available time may be set. In periods of time other than the period of reception-available time, a low-power-consumption operation is performed. Accordingly, the power consumption of the remote controller 100 may be reduced.

The present invention is not limited to the foregoing embodiments, and various modifications may be made within the scope of the invention. For example, the present invention is applicable to a remote control system in which a remote controller and an electronic apparatus are connected to each other in a wired manner. The present invention is further applicable to a process of television shopping in addition to download of content.

1. A remote control method of a remote controller which has a first communication unit capable of performing bidirectional communication and which communicates with a second communication unit capable of performing bidirectional communication so as to remotely control an electronic apparatus connected to the second communication unit, the remote control method comprising:
a step of setting a period of reception-available time of the first communication unit in accordance with a type of an instruction to be transmitted;
a step of transmitting an instruction to the second communication unit;
a step of receiving an instruction for continuing communication from the second communication unit;
a step of updating the period of reception-available time when the instruction for continuing communication is received; and
a step of changing the first communication unit and a controller to be low power consumption states after the period of reception-available time has been elapsed.

2. The remote control method according to claim 1, wherein the period of reception-available time is reset when the instruction is generated again after the instruction is generated.

3. The remote control method according to claim 1, wherein the type of the instruction to be transmitted is set in accordance with content of a process to be executed.

4. The remote control method according to claim 1,
wherein a first low power consumption state in which the minimum power consumption is attained and a second low power consumption state in which power consumption is larger than that in the first low power consumption state but the power consumption is smaller than that in a communication operation of the first communication unit are settable, and
the second low power consumption state is entered when the period of reception-available time is set.

5. A remote controller which operates using a battery power source, the remote controller comprising:
a first communication unit capable of performing bidirectional communication; and
a controller controlling the first communication unit,
wherein the controller sets a period of reception-available time of the first communication unit in accordance with a type of an instruction to be transmitted, generates an instruction to a second communication unit connected to an electronic apparatus, updates the period of reception-available time when an instruction for continuing communication is received from the second communication unit, and changes the first communication unit and the controller to be low power consumption states after the period of reception-available time has been elapsed.

6. The remote controller according to claim 5, wherein the period of reception-available time is reset when the instruction is generated again after the instruction is generated.

7. The remote controller according to claim 5, wherein the type of the instruction to be transmitted is set in accordance with content of a process to be executed.

8. The remote controller according to claim 5,
wherein a first low power consumption state in which the minimum power consumption is attained and a second low power consumption state in which power consumption is larger than that in the first low power consumption state but the power consumption is smaller than that in a communication operation of the first communication unit are settable, and
the second low power consumption state is entered when the period of reception-available time is set.
